(19) United States
(12) Patent Application Publication
(10) Pub. No.: US 2013/0026244 A1
(43) Pub. Date: Jan. 31, 2013

(54) WORK VEHICLE HEATING SYSTEM AND METHOD

(71) Applicants: Leonid Chernyavsky, Glenview, IL (US); Alan Gene Leupold, Plainfield, IL (US); Nicholas Joseph Prenger, Palos Heights, IL (US); Michael Charles Bunnell, Clarendon Hills, IL (US); William Henry Adamson, Naperville, IL (US); Jay Joseph Martin, Joliet, IL (US); Mark Douglas Klassen, Lockport, IL (US)

(72) Inventors: Leonid Chernyavsky, Glenview, IL (US); Alan Gene Leupold, Plainfield, IL (US); Nicholas Joseph Prenger, Palos Heights, IL (US); Michael Charles Bunnell, Clarendon Hills, IL (US); William Henry Adamson, Naperville, IL (US); Jay Joseph Martin, Joliet, IL (US); Mark Douglas Klassen, Lockport, IL (US)

(73) Assignee: CNH America LLC, New Holland, PA (US)

(21) Appl. No.: 13/560,766

(22) Filed: Jul. 27, 2012

Related U.S. Application Data
(60) Provisional application No. 61/512,828, filed on Jul. 28, 2011.

(51) Int. Cl. B60H 1/02; B23P 15/26

(52) U.S. Cl. 237/12; 237/12.3 C; 237/2 R; 29/890.034

(57) ABSTRACT

A work vehicle comprises an internal combustion engine and a catalytic converter coupled to the exhaust of the engine. A reduction agent system provides for injection of a reduction agent, such as urea, upstream of the catalytic converter. Coolant heated by the engine is directed to the reduction agent system to defrost/heat the reduction agent, and is also directed to a vehicle cabin heating system. Flow of coolant may be preferentially directed to the cabin heating system rather than to the reduction agent system, such as following vehicle startup, particularly during cold-weather operation. Flow may be altered to favor the reduction agent system, such as based upon time and/or the temperature of the cabin.

### CROSS REFERENCE TO RELATED APPLICATIONS

This application claims priority from and the benefit of U.S. Provisional Patent Application No. 61/512,828, entitled, “Work Vehicle Heating System and Method,” filed Jul. 28, 2011, which is hereby incorporated by reference in its entirety.

### BACKGROUND

The invention relates generally to the field of work vehicles, and more particularly to vehicles having catalytic converters utilizing selective reduction agents, and to heating arrangements in such vehicles.

Many work vehicles are known for various applications that demand considerable power output and high reliability. Construction and agricultural applications, for example, make use of trucks, tractors, combines, and specialized vehicles of numerous configurations, many utilizing powerful diesel engines as their primary power plant. Historically, these vehicles have emphasized power and reliability first and foremost, with issues such as fuel consumption and emissions being important, but somewhat secondary. Increasingly, however, ever more stringent requirements are being placed on these vehicles to reduce fuel consumption and emissions, while still providing the power output needed for their particular applications.

One standard currently requiring significant redesign in such vehicles is the Tier 4 emission regulations being implemented by the U.S. Environmental Protection Agency. These regulations provide guidance for off-road diesel engines, and affect certain higher horsepower engine ratings. They call for significant reductions in particulate matter (smoke), as well as in oxides of nitrogen. Some adaptations contemplated to address these standards include selective catalytic reduction, in which engine exhaust passes through a catalytic chamber where it is sprayed with a non-toxic mixture of chemical urea (also known as carbamide) and purified water, the urea acting as a selective nitrous oxide (NOx) reduction agent. Other reduction agents may also be used. When the mixture combines with hot exhaust in the catalytic chamber, it is broken down into water vapor and nitrogen. Advantages of such systems include longer service intervals, lower fuel consumption, and wider fuel compatibility.

Problems with such systems can stem from use of the reduction agents at temperatures at which the agents freeze or solidify. For example, aqueous urea solutions containing 32.5% urea, common in such systems, may freeze at or below temperatures of approximately 12° F. For proper operation of the exhaust system, therefore, any vessel containing the urea and/or urea solution must be heated when the vehicle is operated at such temperatures so that the product may be pumped into the exhaust stream. Such heat demands displace heat needed for other purposes, and improvements to such vehicles are needed that balance the use of available heat.

### BRIEF DESCRIPTION

The present invention provides novel techniques for vehicle heating designed to respond to such needs. The techniques may be used for many types of vehicles, such as tractors, combines, off-road and other work vehicles, particularly those employing diesel engines with selective reduction agents and catalytic converters. The techniques seek to utilize available heat in judicious ways to service both the defrosting (and heating) of the reduction agents for reduced emissions, and cabin heating needs.

In accordance with certain aspects of the present disclosure, a vehicle heating system comprises an internal combustion engine that generates heat when operating, and a cooling system configured to circulate a coolant to extract heat from the engine during operation. A catalytic converter is coupled to an exhaust of the engine, and a reduction agent system is configured to hold a reduction agent and to inject the reduction agent into the exhaust upstream of the catalytic converter. A first valve coupled to the cooling system and upstream of the reduction agent system, and is configured to open and close to control flow of the coolant to the reduction agent system to heat the reduction agent. A cabin heating system configured to heat an operator cabin, and a second valve is coupled to the cooling system and upstream of the cabin heating system, and is configured to open and close to control flow of the coolant to the cabin heating system to heat a vehicle cabin. Control circuitry is coupled to the first and second valves, and is configured to control flow of coolant to the reduction agent system and to the cabin heating system.

In accordance with other aspects, a method is provided for heating a vehicle. The method comprises circulating a coolant through an internal combustion engine that generates heat when operating to extract heat from the engine, and directing exhaust from the engine to a catalytic converter. The coolant is preferentially directed through a cabin heating system configured to heat a vehicle cabin rather than through a reduction agent system configured to hold a reduction agent for injection upstream of the catalytic converter. Subsequently, the coolant is preferentially directed through the reduction agent system rather than the cabin heating system based upon at least one of a cabin-related temperature and a predetermined time.

In accordance with further aspects, a method is provided for making a vehicle heating system. The method comprises coupling an internal combustion engine that generates heat when operating to a cooling system configured to circulate a coolant to extract heat from the engine during operation, and coupling a catalytic converter to an exhaust of the engine. A reduction agent system configured to hold a reduction agent and to inject the reduction agent into the exhaust upstream of the catalytic converter is coupled to the exhaust of the engine upstream of the catalytic converter. A first valve is coupled to the cooling system and upstream of the reduction agent system, while a second valve is coupled to the cooling system and upstream of a cabin heating system configured to heat an operator cabin. Control circuitry is coupled to the first and second valves. The control circuitry is configured to control the first and second valves to control flow of coolant to the reduction agent system and to the cabin heating system.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an exemplary work vehicle having a catalytic converter and utilizing engine heat to heat a reduction agent and a vehicle cabin in accordance with the present disclosure;

FIG. 2 is a diagrammatical representation of a portion of an exemplary heating system of the type shown in FIG. 1; and

FIG. 3 is a flow chart illustrating exemplary logic for heating a vehicle cabin and reduction agent.

### DETAILED DESCRIPTION

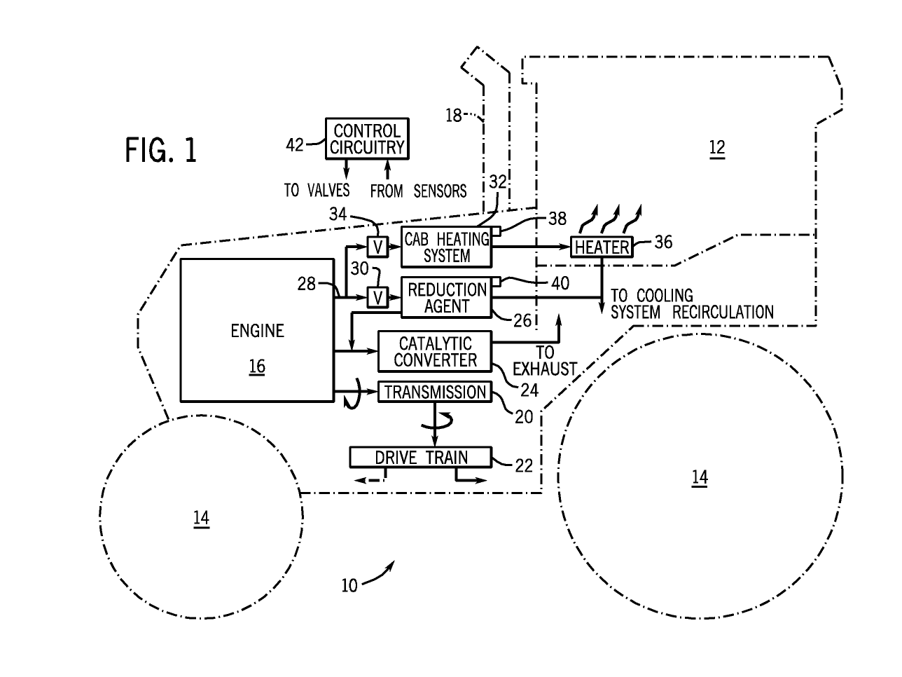

Turning now to the drawings, and referring first to FIG. 1, a work vehicle 10 is illustrated in which a heating system is provided to make multiple use of heat generated by a vehicle engine. FIG. 1 illustrates an exemplary vehicle 10 adapted to use heat from the engine for both cabin heating and defrosting/heating of a reduction agent used for emissions control. In the illustrated embodiment, the vehicle is an agricultural tractor designed to work in fields and other locations to perform various operations, such as ground preparation, seeding and planting, application of fertilizers and chemicals, and so forth. However, the vehicle presently contemplated could have a range of configurations and functions, including, in the agricultural context, combines, articulated vehicles, tracked vehicles, and so forth, and in other contexts, trucks and other work vehicles, both intended for use on roads and off-road. The vehicle 10 has an operator cabin 12 in which an operator will typically sit for controlling operation of the vehicle. Wheels 14 may include driven wheels and non-driven wheels, and serve to propel the vehicle and direct it in operation, although such wheels could be replaced with one or more tracks. A vehicle utilizes an internal combustion engine 16 as a primary power plant. In the presently contemplated embodiment, the engine 16 is a diesel engine that burns a conventional fuel or fuel mixture and produces an exhaust that is expelled through an exhaust outlet 18.

A transmission 20 is coupled to the engine 16 and allows for transfer of mechanical effort to a drive train 22 under the manual or automated control of the vehicle. The drive train, in turn, drives any driven wheels in a conventional manner. The engine exhaust is routed through a catalytic converter 24 that performs conventional chemical processes to reduce certain emissions, such as emissions of oxides of nitrogen (NOx).

Because the engine 16 may operate at lower temperatures that would be otherwise preferred for optimal performance of the catalytic converter 24, a reducing agent system 26 is provided. The reducing agent system will typically include a tank and associated components and plumbing for drawing a reducing agent from the tank for injection, such as in aqueous solution, into the exhaust from engine 16. Such injection is typically reformed upstream of the catalytic converter 24. Although a number of reduction agents may be employed, in a presently contemplated embodiment, urea is used in an aqueous solution as the reduction agent.

The engine 16 is temperature regulated by a cooling system. The cooling system may be, in many respects, conventional insomuch as it circulates a cooling fluid, such as water mixed with an antifreeze or other additive. In a typical application, the cooling fluid is pumped through one or more engine components and out of the engine system as indicated by reference numeral 28. Within the engine or engine system, the fluid may be routed through various heat exchangers, and so forth to extract heat energy produced by the engine. The cooling system will also typically include a thermostat, a radiator, and further components for regulating the flow and temperature of the coolant and thereby of the engine (not separately represented).

In the illustrated embodiment, the cooling system fluid 28 is routed to a first valve 30 that is coupled between the cooling system outlet from the engine and the reduction agent system 26. As described more fully below, the valving 30 may be a two-way (open/closed) valve or may allow for certain modulation (e.g., metering) of coolant flow to the reduction agent system. A second valve 32 is coupled to the cooling system and receives coolant flow from the same or a different outlet from the engine and delivers flow to a cabin heating system 34. The cabin heating system 34 serves to extract heat from the cooling fluid for use by a heat exchanger or heater 36 positioned in the cabin. In certain applications, the cabin heating system 34 may comprise a motor-driven blower (not shown), and the heater 36 may comprise a heat exchanger that transfers heat from the coolant to air in the cabin. Thus, although represented serially in FIG. 1, the fluid from valve 32 may be directed into a heat exchanger, with the cabin heating system being positioned adjacent to the heat exchanger for transfer of heat by forced and/or natural convective movement of the cabin air.

As discussed more fully below, the first and second valves 30 and 32 are controlled to balance or share available heat from the engine for both heating the cabin 12 and for heating the reduction agent system 26. Various schemes may be envisaged for utilization of this available heat as discussed below. In the embodiment illustrated in FIG. 1, one or more sensors 38 will be associated with the cabin and/or the cabin heating system for detecting the temperature of the cabin and/or of the cooling system fluid or a component associated with these, such as a heat exchanger. One or more sensors are also associated with the reduction agent system 26 as indicated by reference numeral 40. Such sensors may detect, for example, the temperature of reduction agent in urea supply conduits, pressure in the holding tank, or any other desired variables. Moreover, other sensors may be provided for sensing the temperature of the coolant, which may also be used to regulate relative flows to the reduction agent system and to the cabin heating system.

These sensors and valves 30 and 32 are coupled to control circuitry 42. This control circuitry may be part of one or more comprehensive control circuits (e.g., electronic control units) that control operation of temperatures in cabin 12, operation of the vehicle, operation of the engine, or any other functions of the vehicle. Although not separately represented, the control circuitry 42 will typically include one or more processors, such as a microprocessor, digital signal processor, or the like, along with associated memory circuitry. The memory circuitry may serve to store settings, configuration parameters, calibration parameters, and so forth, as well as routines executed by the processing circuitry for regulation of any vehicle systems, and in the present context particularly the control of heat extraction by the reduction agent system 26 and the cab heating system 34. Where such control is performed by separate controllers, these may communicate with one another, such as over a vehicle data bus, to coordinate utilization of the engine-generated heat. Accordingly, the control circuitry may also include analog-to-digital converters, valve drive circuitry, and any other necessary support circuitry for receiving signals, processing the signals to carry out the desired functions described in the present disclosure, and driving any actuators, such as valves 30 and 32 for performing these functions. In practice, valves 30 and 32 may comprise solenoid-operated, two-way valves capable of opening and closing to regulate the flow of cooling system fluid to their associated heating systems.

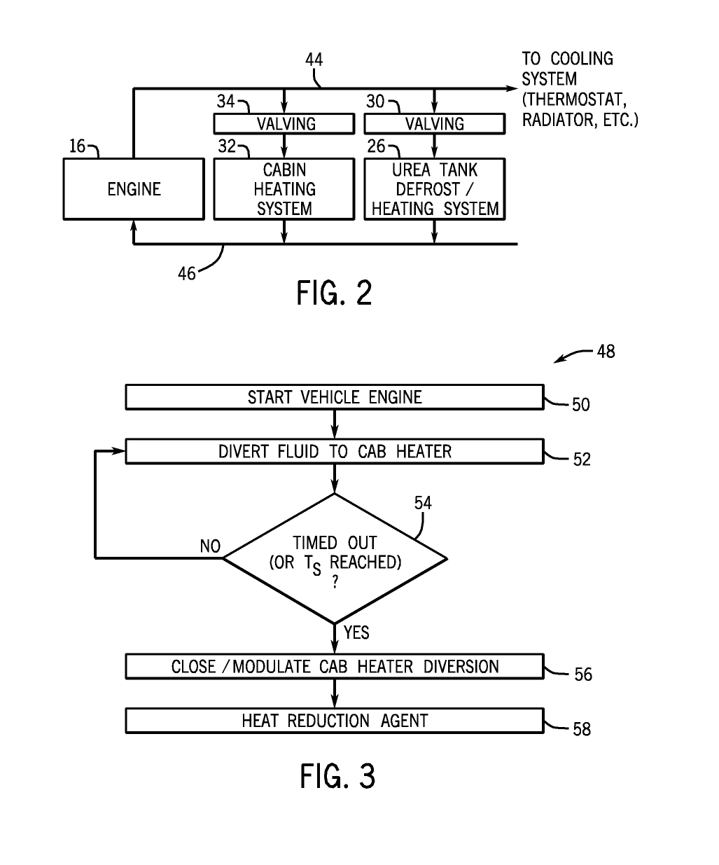

FIG. 2 is a diagrammatical representation of one presently contemplated arrangement for the valving and heating systems discussed above. As shown in FIG. 2, the engine 16 will have circulated through it or certain of its associated components, cooling system fluid (coolant) which will exit through a common supply header 44 (or a different header may be provided) and return through a common return header 46 (or a different header may be provided). The valving 30 and 32 may be coupled in parallel across these headers, with the cabin heating system 34 being coupled at series with valving 32 and the reduction agent heating system being coupled in series with valving 30. In the embodiment illustrated in FIG. 2, the reduction agent heating system is illustrated as including a urea tank defrost/heating system which is a particular implementation of the reduction agent system described above. In such cases, conventional urea or urea solution tanks may be provided in which the reduction agent is stored. One or more lengths of tubing, coils, or any other heat transfer structures may be disposed in or around this tank to receive the cooling system fluid to defrost and/or heat the urea or urea solution. For example, certain mixtures of urea considered to be optimal for the applications, may freeze at temperatures at which the vehicle may be operated, particularly in northern climates and in winter months. In such cases, it will be advisable to defrost and heat the urea or urea solution by extraction of heat from the coolant circulated from the engine. At the same time, however, it may be desirable to extract some of the available heat for warming the cabin by operation of the cabin heating system 34.

FIG. 3 illustrates exemplary logic in a presently contemplated process for utilizing available heat from the vehicle engine for heating both the vehicle cabin and a reduction agent. The process, designated generally by reference numeral 48, may begin at step 50 where the vehicle engine is started. In cold weather conditions, the engine may be started normally or with assistance of various heaters. Once the engine has started, heat generated by the internal combustion process will be extracted by coolant circulated through the engine or engine system components as described above. As indicated at step 52, all or some portion of this fluid may be diverted through the cabin heating system for bringing the cabin up to a comfortable temperature for the operator.

Several possible approaches are presently contemplated for balancing the use of this available heat for cabin heating and for reduction agent heating. For example, in one presently contemplated embodiment, following startup of the engine, fluid is directed through the cabin heating system for a pre-determined time period, such as 20 minutes, during which time no coolant is directed through the reduction agent heating system. Similarly, during a pre-determined time, fluid may be circulated through both the cabin heating system and through the reduction agent heating system, and in certain implementations the relative flow through these two systems may be adjusted so that the reduction agent is heated, while some portion of the heat is diverted for heating the cabin. Still further, a closed-loop approach may be employed in which the temperature of the cabin (or another related temperature) is sensed, and some or all of the engine coolant is directed through the cabin heating system until a set or desired cabin temperature is reached, or until a temperature within a predetermined tolerance range of the set temperature.

Thus, at step 54, the system determines whether the period set for heating the cabin, a temperature set-point (tₛ) is reached, or a combination of these. If the desired time or temperature has not been reached, the diversion of the coolant for cabin heating continues as indicated at step 52. Once the time and/or temperature are reached, the valving directing coolant through the cabin heating system may be closed or regulated to reduce heat extraction, with more heat being extracted by the reduction agent system, as indicated by reference numeral 56. Thereafter, the reduction agent is heated with all or more of the available heat as indicated at reference numeral 58. It should be noted that the system may also, or instead, use sensed coolant temperatures as a basis for regulating relative flows of coolant to one or both of the cabin heating system and the reduction agent heating system.

It should be noted that other components of the vehicle may also utilize some of the available heat at various phases of operation of the vehicle. Similarly, it should be recognized that the cabin heating system 34 may include other means for heating the cabin, such as electric heaters. Nevertheless, it is presently contemplated that at least some of the heat that would otherwise be used for heating the reduction agent will be diverted for punctual heating of the cabin, particularly when cabin temperatures fall below certain points and/or at certain times, such as upon startup of the vehicle. Thereafter, cabin heating may switch to alternate mechanisms, such as electric heaters, although a similar balance of the use of available engine heat may also be performed periodically as needed after initial cabin heating.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A vehicle heating system, comprising:
an internal combustion engine that generates heat when operating;
a cooling system configured to circulate a coolant to extract heat from the engine during operation;
a catalytic converter coupled to an exhaust of the engine;
a reduction agent system configured to hold a reduction agent and to inject the reduction agent into the exhaust upstream of the catalytic converter;
a first valve coupled to the cooling system and upstream of the reduction agent system and configured to open and close to control flow of the coolant to the reduction agent system to heat the reduction agent;
a cabin heating system configured to heat an operator cabin;
a second valve coupled to the cooling system and upstream of the cabin heating system and configured to open and close to control flow of the coolant to the cabin heating system to heat a vehicle cabin; and
control circuitry coupled to the first and second valves and configured to control flow of coolant to the reduction agent system and to the cabin heating system.

2. The system of claim 1, wherein the control circuitry is configured to direct coolant flow to the cabin heating system and not to the reduction agent system during at least a portion of the operation of the vehicle.

3. The system of claim 1, wherein the control circuitry is configured to direct coolant flow to the cabin heating system and not to the reduction agent system during following startup of the vehicle.

4. The system of claim 3, wherein the control circuitry is configured to direct coolant flow to the cabin heating system and not to the reduction agent system for a predetermined time period following startup.

5. The system of claim 3, wherein the control circuitry is configured to direct coolant flow to the cabin heating system and not to the reduction agent system based upon a temperature of the cabin.

6. The system of claim 1, wherein the control circuitry is configured to control coolant flow to the cabin heating system and to the reduction agent system based upon at least one of a predetermined time period and a temperature of the cabin.

7. The system of claim 1, wherein the reduction agent comprises urea.

8. The system of claim 1, wherein the first and second valves are coupled to a common coolant header.

9. The system of claim 1, wherein the first and second valves are coupled to the coolant system upstream of a vehicle thermostat.

10. A vehicle heating method, comprising:
(a) circulating a coolant through an internal combustion engine that generates heat when operating to extract heat from the engine;
(b) directing exhaust from the engine to a catalytic converter;
(c) directing the coolant preferentially through a cabin heating system configured to heat a vehicle cabin rather than through a reduction agent system configured to hold a reduction agent for injection upstream of the catalytic converter; and
(d) directing the coolant preferentially through the reduction agent system rather than the cabin heating system based upon at least one of a cabin-related temperature and a predetermined time.

11. The method of claim 10, wherein in step (c) substantially no coolant is directed through the reduction agent system.

12. The method of claim 10, wherein in step (d) substantially no coolant is directed through the cabin heating system.

13. The method of claim 10, wherein a transition from step (c) to step (d) is made a predetermined time after startup of the vehicle engine.

14. The method of claim 10, comprising controlling flow of coolant to the cabin heating system and the reduction agent system by separate valves under the control of control circuitry.

15. The method of claim 14, wherein the valves draw coolant from a common coolant supply header.

16. A method for making a vehicle heating system, comprising:
coupling an internal combustion engine that generates heat when operating to a cooling system configured to circulate a coolant to extract heat from the engine during operation;
coupling a catalytic converter to an exhaust of the engine;
coupling a reduction agent system configured to hold a reduction agent and to inject the reduction agent into the exhaust upstream of the catalytic converter to the exhaust of the engine upstream of the catalytic converter;
coupling a first valve to the cooling system and upstream of the reduction agent system;
coupling a second valve coupled to the cooling system and upstream of a cabin heating system configured to heat an operator cabin; and
coupling control circuitry to the first and second valves, the control circuitry being configured to control the first and second valves to control flow of coolant to the reduction agent system and to the cabin heating system.

17. The method of claim 16, comprising coupling the first and second valves to a common coolant supply header.

18. The method of claim 16, comprising configuring the control circuitry to direct coolant flow to the cabin heating system and not to the reduction agent system during at least a portion of the operation of the vehicle.

19. The system of claim 18, comprising configuring the control circuitry to direct coolant flow to the cabin heating system and not to the reduction agent system during following startup of the vehicle.

20. The system of claim 16, comprising configuring the control circuitry to direct coolant flow to the cabin heating system and not to the reduction agent system based upon a temperature of the cabin.
